(19) United States
(12) Patent Application Publication
(10) Pub. No.: US 2012/0243461 A1
(43) Pub. Date: Sep. 27, 2012

(54) RELAY HANDOVER CONTROL

(75) Inventors: Paul BUCKNELL, Brighton (GB); Zhaojun LI, Guildford Surrey (GB); Mick WILSON, Romsey Hampshire (GB)

(73) Assignee: FUJITSU LIMITED, Kawasaki-shi (JP)

(21) Appl. No.: 13/490,986

(22) Filed: Jun. 7, 2012

Related U.S. Application Data
(63) Continuation of application No. PCT/GB2009/002868, filed on Dec. 10, 2009.

(51) Int. Cl. H04W 36/00; H04W 88/04

(52) U.S. Cl. 370/315

(57) ABSTRACT

A method is provided in handover of a user equipment in a communications system from communicating with a donor node via a relay node, to communicating with a target node, the donor node being operable to transmit downlink data to the relay node in a series of sequentially marked donor packets, the relay node being operable to then transmit the downlink data to the user equipment in a series of sequentially marked relay packets. The method includes receiving a handover request at the donor node and, upon receipt, beginning buffering of the donor packets in a temporary buffer at the donor node, transmitting a status message from the relay node to the donor node indicating a first of the relay packets not received by the user equipment, transmitting an update message from the donor node to the relay node indicating the first donor packet buffered in the temporary buffer.

This is a continuation of International Patent Application No. PCT/GB2009/002868, filed Dec. 10, 2009, now pending, the contents of which are herein wholly incorporated by reference.

The present invention relates to the field of telecommunications, and in particular to performing handover of a user equipment (UE) from one base station to another. The invention may be used in communications systems operating according to OFDMA systems such as those used in WiMAX, Universal Mobile Telecommunications System (UMTS), Code Division Multiple Access (CDMA) protocols, the GSM EDGE Radio Access Network (GERAN), or other telecommunications protocols. Specifically, the invention may be used in telecommunications protocols in which relay stations relay downlink data from a base station to a user equipment.

One particular application is in UMTS, also known as 3G. UMTS wireless communication systems are being deployed worldwide. Future development of UMTS systems is centred on the so-called evolved UMTS terrestrial radio access network (evolved UTRAN or eUTRAN), more commonly referred to by the project name LTE.

LTE is a technology for the delivery of high speed data services with increased data rates for the users. Compared to UMTS and previous generations of mobile communications standards, LTE will also offer reduced delays, increased cell edge coverage, reduced cost per bit, flexible spectrum usage and multi-radio access technology mobility.

LTE has been designed to give peak data rates in the downlink (DL) direction, communication away from a base station (BS) towards a user equipment of >100 Mbps, whilst in the uplink (UL) direction, communication away from the user equipment towards the BS, of >50 Mbps.

LTE-Advanced (LTE-A), which is a development currently being standardized, will further improve the LTE system to allow up to 1 GBps in the downlink and 500 Mbps in the uplink. LTE-A will use new techniques to improve the performance over existing LTE systems, particular for the transmission of higher data rates and improvements to cell edge coverage.

LTE-Advanced and LTE share a common basic architecture and network protocol architecture. As in current UMTS systems, the basic architecture proposed for LTE consists of a radio access network (the eUTRAN) connecting users (or more precisely, user equipments) to access nodes acting as base stations, these access nodes in turn being linked to a core network. In eUTRAN terminology the access node is called an enhanced Node Basestation or eNB. A separate radio network controller (RNC) as used in previously-proposed systems is no longer required, with some of its functions being incorporated into the eNB, some into the Mobility Management Entity (MME), and some into the System Architecture Evolution GateWay (SAE GW). The eNBs connect to the core network which, in LTE, is referred to as the evolved packet core (EPC).

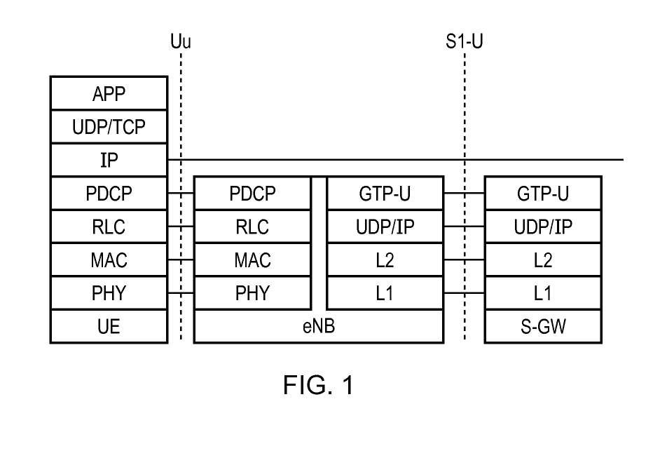

FIG. 1 shows the relationship between protocol layers for LTE. The Packet Data Convergence Protocol (PDCP) is the top sublayer of the LTE user plane layer 2 protocol stack, above the Radio Link Control (RLC) layer. The PDCP layer processes control plane messages, such as Radio Resource Control (RRC) messages, in the control plane and user plane packets, such as Internet Protocol (IP) packets, in the user plane. Depending on the radio bearer, the main functions of the PDCP layer are header compression, security (integrity protection and ciphering), and support for reordering and retransmission during handover. PDCP packets include a Sequence Number (SN) that enables in-order delivery of packets to the upper layers and identification of missing packets with potential re-transmission of those missing packets. Sequence numbers are also used for security in ciphering of the user plane and control plane, and additionally for integrity protection of RRC data in the control plane. An equivalent protocol structure exists in the 3G protocol.

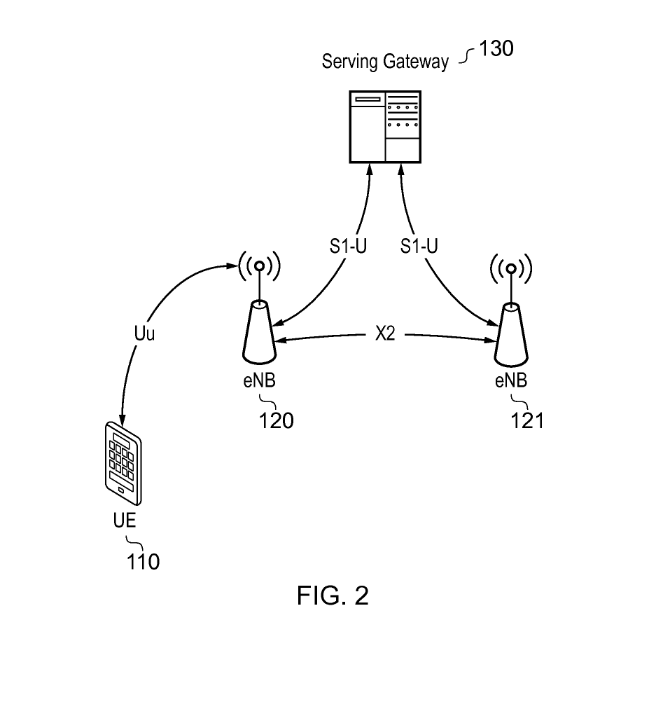

FIG. 2 illustrates the network topology between the user equipment 110, two enhanced Node Basestations 120, 121, and the Serving GateWay 130 (SGW or S-GW). The Uu radio interface is marked, corresponding to the dashed line marked ‘Uu’ in FIG. 1, likewise the S1-U interface marked on FIG. 2 corresponds to the dashed line marked ‘S1-U’ in FIG. 1. The user equipment 110 and eNB 120 communicate over the Uu radio interface. The two eNBs 120 and 121 communicate with one another via a wired X2 interface.

LTE-Advanced extends LTE Rel-8 by providing support for relaying as a tool to improve data throughput to user equipment at the cell edge. Relaying can also improve group mobility, temporary network deployment, and/or provide coverage in new areas. LTE-Advanced is used as an illustrative example, but relaying is supported in other telecommunications protocols, for example, a similar relaying technique exists in the IEEE standard 802.16j.

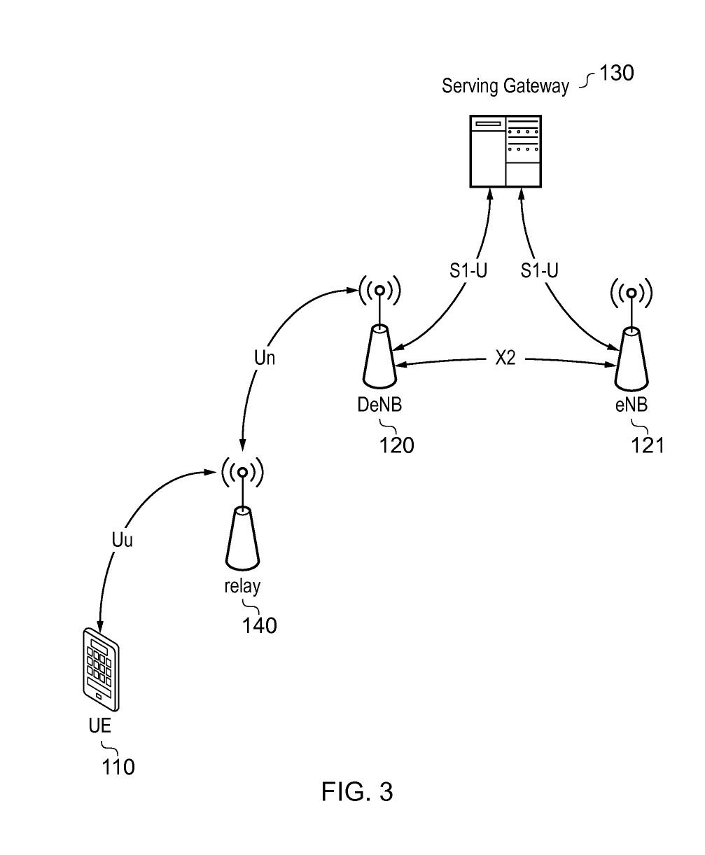

FIG. 3 shows the network topology in a configuration in which the user equipment 110 communicates with a Donor enhanced Node Basestation (DeNB) 120 via a relay node 140. The user equipment 110 communicates with the relay node 140 over the Uu radio interface. The relay node 140 communicates with the DeNB 120 over the Un radio interface. The DeNB 120 and eNB 121 communicate via an X2 interface. The DeNB 120 and the eNB 121 each communicate with the sGW 130 via an S1-U interface.

Relay node 140 wirelessly connects to the radio access network via a donor node 120 serving a donor cell. LTE-A in particular provides support for relay nodes with an ‘inband’ connection, in which the network-to-relay link shares the same band as direct network-to-UE links within the donor cell served by the donor node. Other telecommunications protocols may also support ‘outband’ connections, in which the network-to-relay link does not operate in the same band as direct network-to-UE links within the donor cell served by the donor node. Specifically, LTE-A supports ‘type 1’ relay nodes. A type 1 relay node is characterised by the following, as set out in TR 36.912 (“Feasibility Study for Further Enhancements for E-UTRA (LTE-Advanced)”):
it controls one or more cells, each of which appears to a user equipment as a separate cell distinct from the donor cell;
the one or more cells shall have their own Physical Cell ID (defined in LTE Rel-8) and transmit their own synchronization channels, reference symbols and other parameters;
in the context of single-cell operation, the user equipment receives scheduling information and HARQ feedback directly from the relay node and sends its control channels (SR/CQI/ACK) to the relay node.

When relays are used, the problem of avoiding data loss during a handover becomes more difficult than in a ‘normal’ handover (eNB to eNB). In general, ‘handover’ refers to any change in a user equipment's serving cell, whether or not involving a change in eNB (it is possible for one eNB to provide multiple cells depending on the antenna configuration). In this specification, however, ‘handover’ usually refers to the process of a user equipment ceasing to be attached to a first, ‘source’ node, being a relay node, and instead becoming attached to a second ‘target’ eNB, thus transferring responsibility for the user equipment from the source to the target eNB (usually as a result of the user equipment having moved closer to the target eNB).

A cause of difficulty in the case of handovers involving a relay node as the source node is the involvement of two radio interfaces in the handover: the Uu radio interface between the source or target node and the user equipment, and the Un radio interface between the source and target node and the relay.

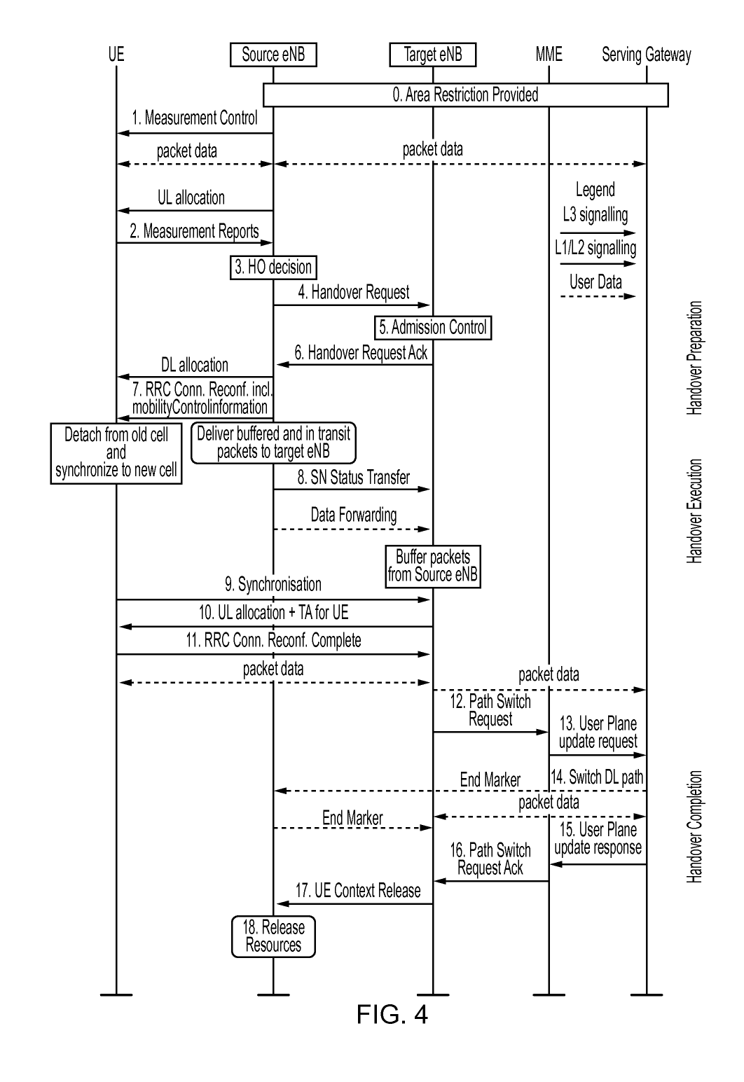

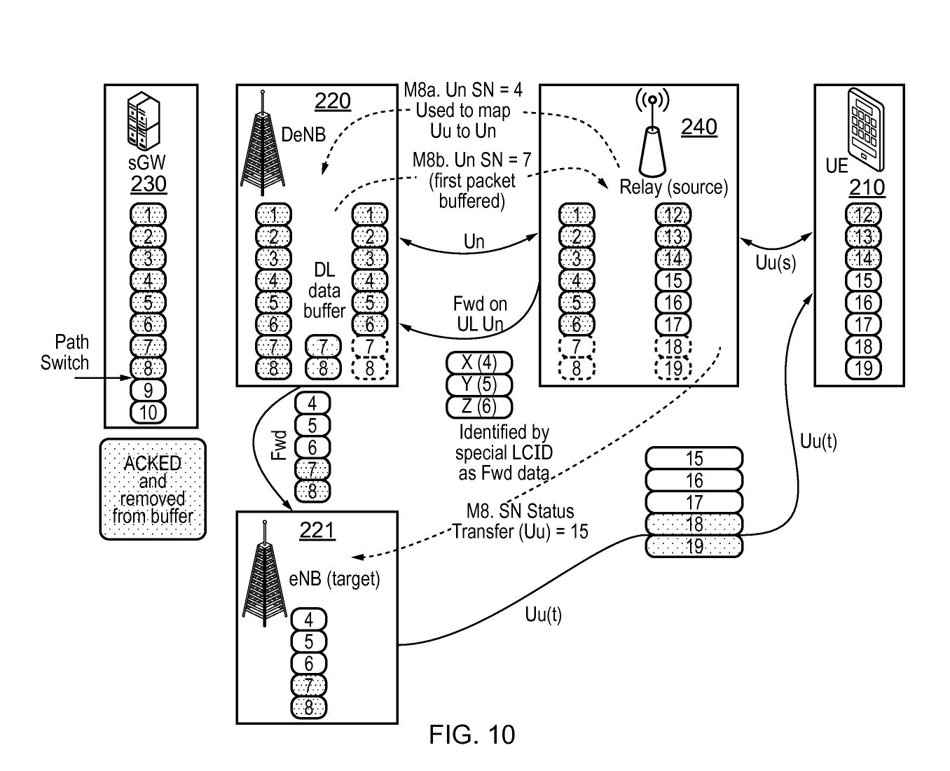

3GPP TS 36.300 v9.1.0 (2009-09) (3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2; Technical Specification (Release 9)) at FIG. 10.1.2.1.1-1 (reproduced in this application as FIG. 4), shows a handover performed by the exchange of messages directly between eNBs. The release of resources at the source side during the handover (HO) completion phase is triggered by the eNB.

R2-093735 (3GPP TSG RAN WG2 Meeting #66bis Los Angeles, USA, Jun. 29-Jul. 3, 2009, “Joint PDCP protocols on Uu and Un interfaces to improve type-1 relay handover”) details a method for handover of a user equipment from a relay station (acting as the source node) to a target station in which the PDCP sequence numbers used over the Un interface (between the relay station and donor station) are linked to the PDCP sequence numbers used over the Uu interface (between the user equipment and the relay station/target station). Packets are transferred from a serving GateWay (sGW) to a Donor enhanced Node Base station (DeNB), the DeNB being both the controlling base station for the relay, and the target of the handover. Typically this would occur when a user equipment is moving out of the coverage area of the relay node and into the coverage area of the DeNB. Before handover, the packets are all buffered at the DeNB and transmitted over the Un radio interface to the relay. In turn, the relay transmits the packets to the user equipment over the Uu interface. The relay also stores the packets in a buffer.

Once packets are successfully transferred to the user equipment, they are deleted from the buffers in both the relay and the DeNB. However, if a handover occurs because, for example, a user equipment has moved out of the coverage area of the relay and into the coverage area of the target, in this case the DeNB, then some packets may not be successfully transmitted from the relay to the user equipment. Such unsuccessfully transmitted packets are queued at the relay for retransmission (though successful retransmission is unlikely).

Due to the handover, the DeNB stops sending packets to the relay. However, it is likely that several packets have been transmitted to the relay in the period from the initial unsuccessful packet transmission and the DeNB stopping sending packets to the relay.

A PDCP status report from the relay node to the DeNB informs the DeNB of the PDCP sequence numbers of packets which are fully acknowledged in the user equipment, and which are not. Due to the linking of the PDCP sequence numbers used over the Uu interface to those used over the Un interface, the relay is able to translate Uu PDCP sequence numbers into Un PDCP sequence numbers. Finally, the DeNB can remove data packets identified as successfully received by the user equipment from the buffer.

The method described in R2-093735 has several disadvantages:
because data is always buffered in DeNB until successfully acknowledged as being in the user equipment, the buffer in the DeNB will have to be large;
if PDCP SN status gets lost then DeNB buffer may overflow;
tying PDCP numbers from the Un and Uu radio interfaces reduces flexibility;
this method depends on periodic PDCP status reports to identify which packets are received by the user equipment—these reports represent an overhead over the radio interface, which is a valuable resource.

X2 signalling is a status transfer for both downlink and uplink data, and allows communication of control plane signalling and the transfer of user plane data packets during handover. In LTE networks the X2 interface is optionally set up between a DeNB and a relay to allow the handover of data. R2-094559 (3GPP TSG-RAN WG2 #67, Shenzhen, PR China, 24 Aug.-28 Aug., 2009, “UE handover for Type-1 relay”) describes two mechanisms for managing a handover of user equipment from a relay to a target node. In the first, the DeNB does not monitor the X2 signalling to/from the relay. However, after the DeNB receives notification from the relay that a user equipment handover is about to occur, it begins buffering the data being directed to the user equipment. The start of this buffering must be initiated by the relay, since the DeNB does not monitor the X2 signals to/from the relay, for example, it could be via a ‘tunnel set-up command’. Once the DeNB starts buffering data, it stops the downlink data transmission to the user equipment. The buffered data is directly forwarded to the target node later.

‘End marker for relay’ (EM_R) data packets are sent between the DeNB and the relay. When the relay receives an EM_R it knows that for the user equipment in question, the DeNB will no longer forward downlink data packets. When the DeNB receives an EM_R from the relay, it learns that all the downlink data buffered on the relay but not yet acknowledged by the user equipment has been sent back to the DeNB. The received data from the relay is then forwarded from the DeNB to the target node.

In the second mechanism, the DeNB monitors the X2 signalling to/from the relay. Therefore, a ‘start marker for relay’ (SM_R) packet is inserted into the downlink data as soon as the handover request is received by the DeNB, and the DeNB buffers all downlink data intended for the user equipment following the SM_R. The SM_R is in advance of buffering, and hence cannot contain any information regarding which packets have been buffered. Both the relay and the DeNB set the packet following the SM_R as the first packet, so that the downlink data packets are synchronised. A relay handover status report from the relay to the DeNB notifies the DeNB of those packets successfully delivered to the user equipment and those not. Non-acknowledged packets are sent directly from the DeNB to the target node. Any non-acknowledged packets from before the SM_R are forwarded from the relay to the DeNB following the status report.

According to an embodiment of a first aspect of the present invention, a method is provided in handover of a user equipment in a communications system from communicating with a donor node via a relay node, to communicating with a target node, the donor node being operable to transmit downlink data to the relay node in a series of donor packets, the donor packets being sequentially marked, the relay node being operable to then transmit the downlink data to the user equipment in a series of relay packets, the relay packets also being sequentially marked. The method comprises receiving a handover request at the donor node and, upon receipt, beginning buffering of the donor packets in a temporary buffer at the donor node, transmitting a status message from the relay node to the donor node indicating a first of the relay packets not considered to have been received by the user equipment, and transmitting an update message from the donor node to the relay node indicating the first donor packet buffered in the temporary buffer.

Advantageously, buffering downlink data in the temporary buffer only after receiving a handover request is more efficient than buffering downlink data in this way during normal operation.

Advantageously, the defined exchange of messages between the relay node and the donor node can enable the donor node to identify which data considered not to have been delivered to the user equipment are not stored in the temporary buffer, if any. It is data not considered to have been successfully received by the user equipment that may require forwarding to the target node, depending on the communications protocol and the identity of the target node. Therefore, the relay node should be made aware of the data packet marking the beginning of the temporary data buffer. If any forwarding of undelivered data packets is required by the relay, the knowledge of which data packets, and hence which data, is stored in the temporary buffer will inform the decision of which data to forward.

Furthermore, when the communications system is operating in a mixed network comprising LTE and LTE-A eNBs, and the target node is an LTE eNB, the method embodying the present invention minimises the changes that have to be made to the LTE eNB in order to receive the user equipment from a relay node acting as a source node.

Embodiments of the present invention may enable a handover to occur without data loss. Specifically, the delivery of data packets from the relay node to the user equipment can stop, and data packet delivery resume from the target node to the user equipment, without losing data packets during the handover process.

The user equipment may be a mobile terminal, such as a telephone or PDA, but is not limited to such devices. For example, a desktop type personal computer may connect to a relay node of such a communications system.

The communications system may be a wired or wireless communications system, though in further embodiments some features may be restricted to use in wireless communications systems. In particular, the communications system is suitable to operate according to the LTE-Advanced communications protocol. In the case of the LTE-advanced protocol, the donor node is an eNB access node. As a further alternative, it may be that the communications system is operating in a mixed network including LTE eNBS and LTE-A eNBs. In such networks, the donor node should be an LTE-A eNB, but the target node could be an LTE eNB or an LTE-A eNB.

It is often the case that the target node is the donor node. Typically this would occur when a user equipment is moving out of the coverage area of the relay node and into the coverage area of the donor node.

Data packets, being sequentially marked, may include a sequence number, or some other information that can be added to define a packet's position within a range in order to allow unambiguous sequencing of data. A donor packet is a data packet sent from the donor node to the relay node. The term donor packet is used to distinguish from relay packets, which are data packets sent from the relay node to the user equipment. Both donor packets and relay packets can be thought of merely as data packets containing, for example, user data. Preferably, each donor packet corresponds to a relay packet containing the same downlink data, or a copy thereof. This correspondence may be a one-to-one correspondence, in which each relay packet contains the downlink data from one and only one donor packet. The header data, sequential marking, or other information may distinguish the relay packet from the corresponding donor packet. Alternatively, the relay packet may be the donor packet or a verbatim copy of the donor packet, so that they can actually be considered to be same packet.

The handover request may be a message transmitted by the relay node acting as the source node (the serving node before handover). Handover is usually performed when the offset in a measured quantity of the serving cell (area served by the serving node) to a neighbouring cell becomes bigger than a configured threshold and a configured time-to-trigger has elapsed. Alternatively, handover could be prompted by, for example, the falling of a quality of service (QoS) measurement below an acceptable threshold, or it may be prompted by some other factor, for example, by virtue of the relative distances to the source and target nodes.

Following the handover, the user equipment can communicate directly with the target node. However, the target node may itself be a relay node. The target node may also be an eNB, a Home enhanced Node Basestation (HENB), or the donor node.

Optionally, the relay node will disassemble the donor packets and reassemble them as relay packets, potentially with different sequential markings, but still containing some or all of the downlink data. Though the sequential markings are different, the sequence is maintained. This can be considered to be repackaging of the downlink data.

The temporary buffer is additional to the conventional transmission buffer which stores data packets (or a copy thereof) until receipt is acknowledged by the relay node, and the temporary buffer does not remove packets once acknowledgment of delivery is received from the relay node. The temporary buffer stores the donor packets (or a copy thereof). The buffering in the temporary buffer may begin immediately after receipt of the handover request, or it may begin once the process of admission control has begun at the donor node.

The status message may merely indicate the first relay packet transmitted by the relay node and not considered to have been received by the user equipment using a sequential marking of the packet. It is also possible that this status message contains more detailed information on exactly which packets from a sequence of transmitted packets need to be forwarded, for example, in the case where some packets were acknowledged by the user equipment and some were not. This could be achieved by using a bitmap in addition to, or as part of, the status message to indicate which bits were successfully received by the user equipment, and which were not.

A data packet may be considered not to have been delivered because it was never transmitted to the user equipment by the relay node, or it may be considered never to have been delivered because delivery was not acknowledged by the user equipment. Such an acknowledgement could be, for example, in the form of an acknowledgment message transmitted from the user equipment to the relay node. The precise conditions for a data packet to be considered not to have been delivered are dependent on the communications protocol to which the method is applied.

The status message in embodiments using the LTE or LTE advanced protocols may be sent as a PDCP control information message, or as an RRC message.

Preferably, the update message is transmitted from the donor node to the relay node and indicates a sequential marking carried by the first data packet to be stored in the temporary buffer.

The update message in embodiments using the LTE or LTE advanced protocols may be sent as a PDCP control information message, or as an RRC message.

According to embodiments of an aspect of the present invention, the method also includes forwarding uplink, from the relay node to the donor node, all downlink data from relay packets not considered by the relay node to have been received by the user equipment and which are sequentially earlier than the first donor packet buffered in the temporary buffer. The relay node will be aware which of the data packets are not considered to have been delivered to the user equipment, and, following receipt of the update message, will also be aware which data packet is the sequentially earliest (first) to be stored in the temporary buffer.

Forwarding the data from undelivered data packets which are sequentially earlier than the start of the temporary buffer to the donor node ensures that the donor node has a copy of all downlink data not successfully delivered to the user equipment. If the donor node is the target node, then retransmission can be attempted. If the donor node is not the target node, then the downlink data not successfully delivered to the user equipment can be forwarded to the target node.

Forwarding the data from the undelivered packets may include disassembling and reassembling the data packets so that the sequential markings are independent of those used in transmission from the donor to the relay, though preserving the sequence of the data packets.

Data packets forwarded from the relay node to the donor node are uplink data packets. It is a problem in some proposed handover methods that data packets of undelivered data forwarded from the relay node to the donor node, that is, in the uplink direction, cannot be distinguished from other uplink data and thus are not identified by the donor node as data for retransmission to the user equipment or for forwarding to the target node. Preferable embodiments of the present invention further comprise accompanying said forwarded data packets with an indication to the donor node that the data in the forwarded data packets are intended for forwarding to the target node of the handover request.

These forwarded packets could receive new sequential markings, or could be identified to the donor node by a dedicated radio bearer (RB) identity (Logical Channel ID), and/or by embedding the sequential markings originally used for transmitting the donor packets from the donor node to the relay node (eg Un PDCP SNs). Alternatively, the sequential markings used for transmitting the relay packets from the donor node to the relay node (eg Uu PDCP SNs) can be embedded instead, but this will only be effective if the mapping between each set of sequential markings is known at the donor node. The forwarded data packets could also be identified to the donor node by the addition of a header field to the data. One example is the use of the GTP-U protocol (General Packet Radio Service Tunnelling Protocol) according to which a header may be added to the data packets identifying them as forwarded data.

Where methods embodying the present invention are used in a case in which the donor node is not also the target node, the method preferably includes forwarding data from the donor packets in the temporary buffer from the donor node to the target node. These are data that may not have been successfully transmitted to the user equipment yet, and hence it is desirable to forward them to the target node for transmission to the user equipment.

Where donor packets are disassembled and reassembled, or simply renumbered, at the relay node for transmission to the user equipment as relay packets, the donor node may not be aware which of the markings used in the relay packets correspond to which donor packets stored in the temporary buffer. Optionally, the sequential markings of the donor packets are different from the sequential markings of the relay packets, and each relay packet corresponds to a donor packet in that the relay packet contains the downlink data from the corresponding donor packet, and the status message uses the sequential marking of the corresponding donor packet to identify the first of the relay packets not considered to have been received by the user equipment.

Advantageously, using the donor packet sequential markings in this way enables the donor node to ensure that, once forwarded data is received from the relay node in data packets having sequential markings of the corresponding donor packets, the correct data is forwarded to the target node.

Preferably, the order of the data from the donor packets is retained upon reassembly into relay packets. The sequential markings may be different from one another in the sense that they employ the same numbering system, but one is offset with respect to the other, so that there is a gap or an overlap between the two sets of markings. Alternatively, a different system of markings may be employed in each set of sequential markings.

Preferred embodiments of the present invention include transmitting a further status message from the relay node to the target node indicating, using the sequential marking of the relay packet, the first relay packet not considered to have been received by the user equipment.

Advantageously, a combination of the status message and the further status message detailed above will allow the target node to effectively map sequential markings used in transmitting relay packets to the user equipment onto the corresponding data packets forwarded from the donor node (numbered using donor packet sequential markings), or, in the case where the donor node is the target node, to map the relay packet sequential markings onto the data packets in the temporary buffer. Any data packets subsequently forwarded or retransmitted from the target node to the user equipment can be marked correctly. Such data packets can then be received by the user equipment and processed in the correct order and without errors arising due to gaps in the sequence.

In the handover scenario to which embodiments of the present invention are applied, the relay node is the source node. Once a handover request is issued by the relay node, the relay node will shortly cease transmitting downlink data to the user equipment. However, in embodiments of the present invention, there is a finite period of time between receipt of the handover request at the donor node, and detachment of the user equipment from the relay node. During this finite period of time, the donor node stores all downlink data packets received in a temporary buffer. Embodiments of the present invention may further include transmitting the data from a data packet in the temporary buffer from the donor node to the relay node. Advantageously, the relay node can then continue transmission of data packets to the user equipment in order to reduce the number of packets that are not successfully transmitted to the user equipment.

Furthermore, should the handover be unsuccessful, the relay has the data packets and can promptly resume transmission; a faster recovery is allowed in the case of handover fall back. Optionally, there may be a defined configuration, for example an RRC (Radio Resource Control) configuration, which is used to decide whether or not the function of continuing to transfer data from the temporary buffer to the relay node is active or not.

Preferably, embodiments of the present invention further comprise, at the donor node, upon receiving acknowledgment that the copy of the data packet has been received by the relay node, retaining the corresponding data packet in the temporary buffer. During handover it is not assumed that packets delivered from the donor node to the relay node will be successfully delivered to the user equipment. Therefore, retaining in the temporary buffer of the donor node a data packet corresponding to the data packet delivered to the relay node will obviate the need to forward the delivered data packet in the uplink direction to the donor node for retransmission directly to the user equipment or for forwarding to the target node.

In a case where a series of relay packets not considered to have been successfully received by the user equipment is broken by occasional relay packets that are successfully delivered to the user equipment, the data from the successfully delivered relay packets may be needlessly forwarded from the relay node to the donor node for retransmission to the user equipment, either via a separate target node or directly. Optionally, embodiments of the present invention may also include transmitting, from the relay node to the donor node, an indication of the relay packets, from a defined sequence of relay packets, not considered to have been received by the user equipment. This indication could be included in the status message in the form of more detailed information on exactly which packets from a sequence of transmitted packets need to be forwarded from the relay node to the donor node, for example, a bitmap included in, or transmitted in addition to, the status message to indicate which data were successfully delivered to the user equipment. Alternatively, a separate status report could be sent from the relay node to the donor node after the update message. In either case, the amount of forwarded data could be reduced. The bitmap may be eventually transmitted to the user equipment for use in ordering received data for processing.

According to another aspect of embodiments of the present invention, a method is used in a communications system operating according to a LTE-A protocol. Preferably, in such methods the donor node is a donor enhanced node base station according to the LTE-A protocol.

According to another aspect of embodiments of the present invention, a communications system is provided which is operable to perform a handover from a first configuration in which a user equipment communicates with a donor node via a relay node, to a second configuration in which the user equipment communicates with a target node, wherein when communicating according to the first configuration, the donor node is operable to transmit downlink data to the relay node in a series of donor packets, the donor packets being sequentially marked, and the relay node is operable to then transmit the downlink data to the user equipment in a series of relay packets, the relay packets being sequentially marked. In performing the handover, the donor node is operable to receive a handover request and, upon receipt, to begin buffering of the donor packets in a temporary buffer; the relay node is operable to transmit a status message to the donor node indicating a first relay packet not considered to have been received by the user equipment; and the donor node is operable to transmit an update message to the relay node indicating the first donor packet buffered in the temporary buffer.

According to another aspect of the present invention, a relay node is provided for use in a communications system operable to perform a handover from a first configuration in which a user equipment communicates with a donor node via the relay node, to a second configuration in which the user equipment communicates with a target node, wherein when communicating according to the first configuration, the relay node is operable to receive downlink data from the donor node in a series of donor packets, the donor packets being sequentially marked, and to transmit the downlink data to the user equipment in a series of relay packets, the relay packets being sequentially marked. In performing the handover the relay node is operable to transmit a status message to the donor node indicating a first relay packet not considered to have been received by the user equipment; and the relay node is operable to receive from the donor node an update message indicating the first donor packet buffered in a temporary buffer which began buffering donor packets upon receipt of a handover request at the donor node.

According to another aspect of embodiments of the present invention, a computer program is provided which, when executed on a computing device of a telecommunications node, causes the node to become the relay node defined above.

According to another aspect of embodiments of the present invention, a donor node is provided for use in a communications system operable to perform a handover from a first configuration in which a user equipment communicates with the donor node via a relay node, to a second configuration in which the user equipment communicates with a target node, wherein when communicating according to the first configuration, the donor node is operable to transmit downlink data to the relay node in a series of donor packets, the donor packets being sequentially marked, for subsequent transmission to the user equipment as a series of relay packets also being sequentially marked. In performing the handover the donor node is operable to receive a handover request and, upon receipt, to begin buffering of the donor packets in a temporary buffer, and to receive a status message from the relay node indicating a first relay packet not considered to have been received by the user equipment; and the donor node is operable to transmit an update message to the relay node indicating the first donor packet buffered in the temporary buffer.

According to another aspect of embodiments of the present invention, a computer program is provided which, when executed on a computing device of a telecommunications node, causes the node to become the donor node defined above.

The skilled reader will appreciate that features of embodiments of the invention as described or claimed may be readily combined with features of other embodiments. In particular, the communications system, relay node, donor node, or other apparatus as described may have the means or functionality to perform the described methods.

Exemplary embodiments of the present invention shall now be described, purely by way of example, by reference to the accompanying drawings in which:

FIG. 1 shows the relationship between protocol layers for LTE;

FIG. 2 shows a simple network architecture for LTE;

FIG. 3 shows an LTE network architecture including a relay node;

FIG. 4 shows a handover performed by the exchange of messages directly between eNBs in the prior art;

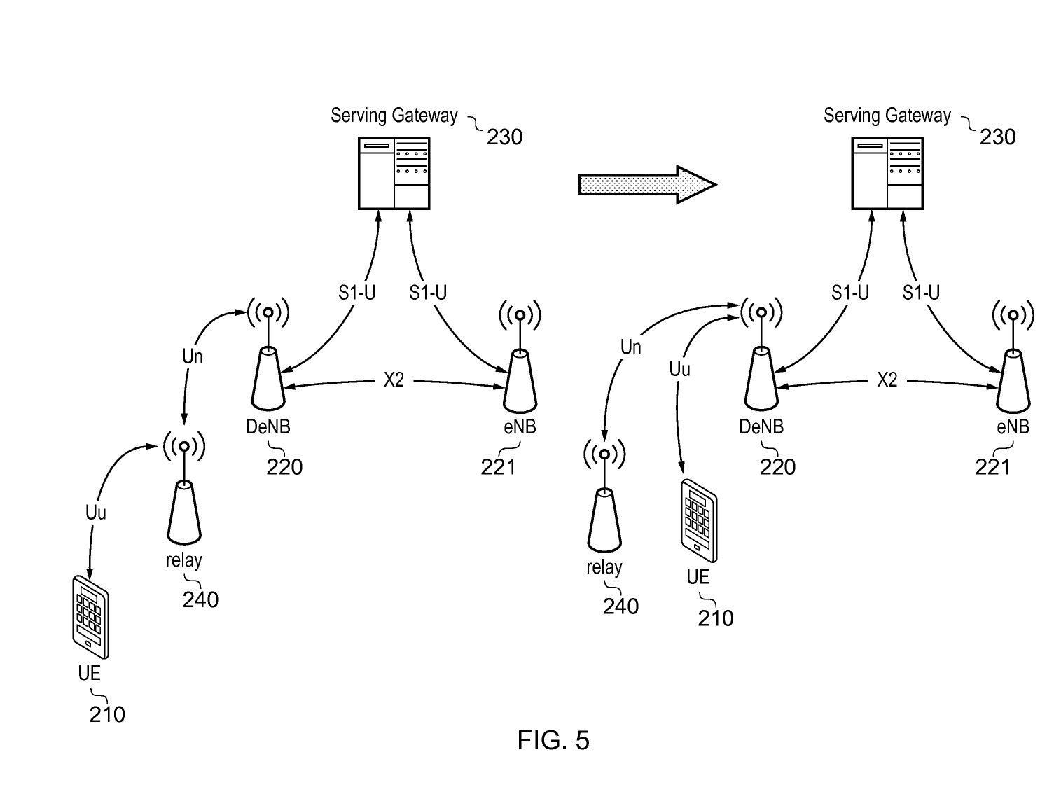

FIG. 5 illustrates a handover in which the source node is a relay node and the target node is the associated donor node;

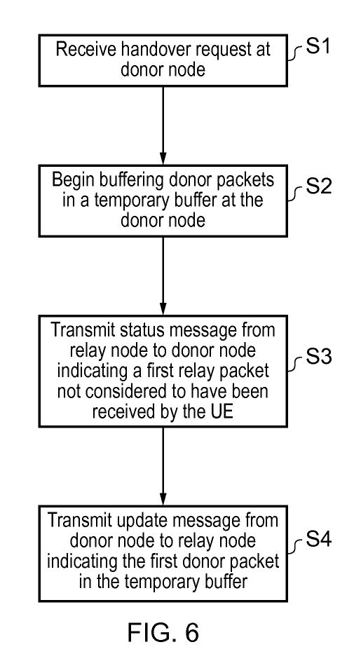

FIG. 6 is a flow chart representing a method embodying the present invention;

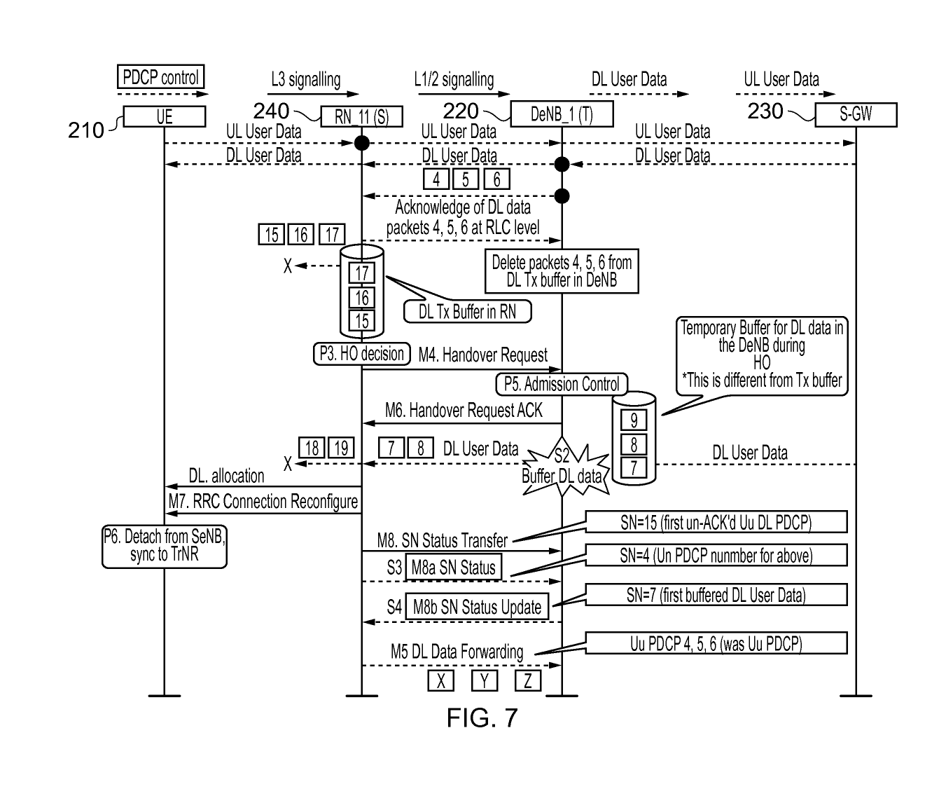

FIG. 7 is a schematic diagram of a control signalling and buffering process embodying the present invention;

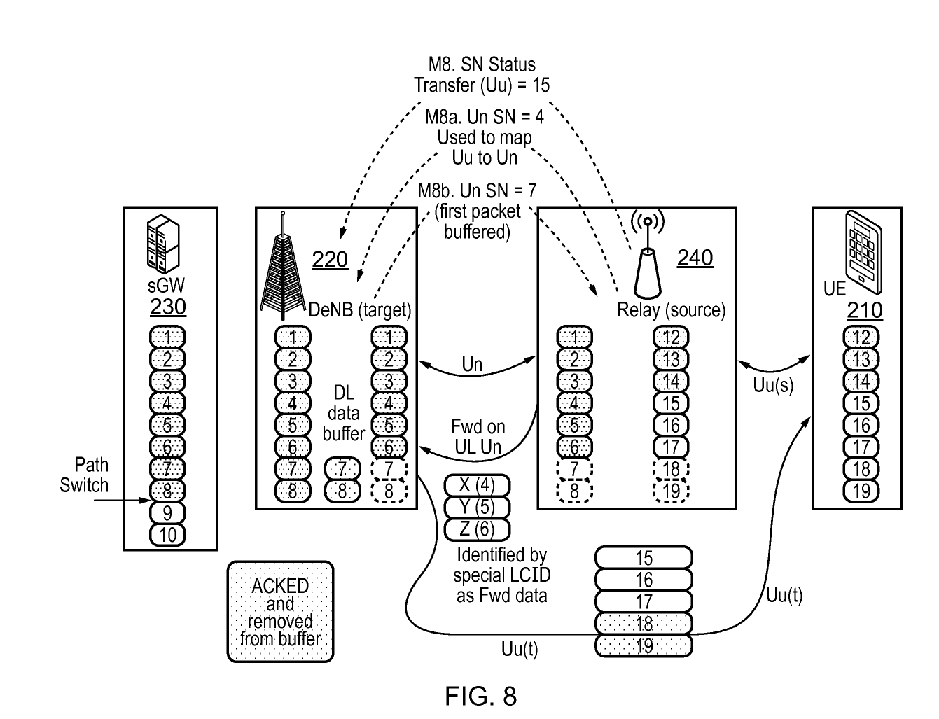

FIG. 8 is a diagram showing sequence number signalling in the control of data forwarding in an embodiment of the present invention;

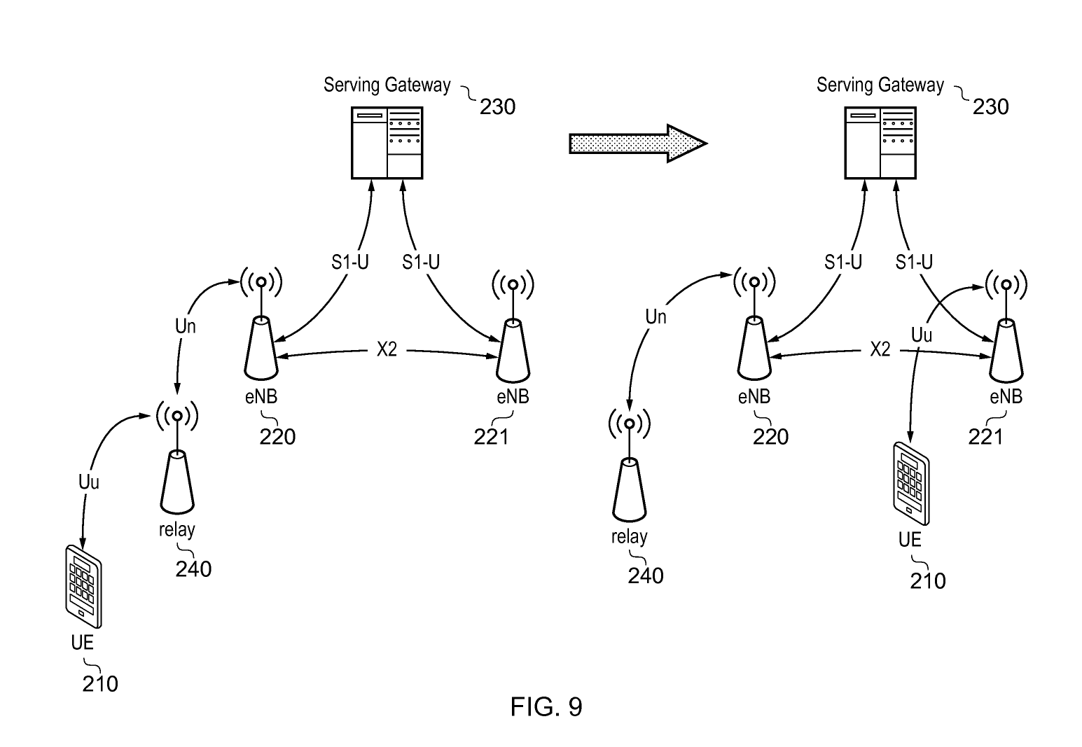

FIG. 9 illustrates a handover in which the source node is a relay node and the target node is an eNB other than the donor node;

FIG. 10 is a diagram showing sequence number signalling in the control of data forwarding in an embodiment of the present invention in which the target node is an eNB other than the donor node.

FIG. 5 shows components in a communication system and the interfaces between the components. A first, pre-handover, configuration is shown to the left of the arrow. To the right of the arrow is a second, post-handover, configuration.

The first configuration shows a user equipment 210 communicating with a relay node 240 over a radio interface Uu. The relay node 240 communicates with a Donor enhanced Node Basestation (DeNB) 220 over a Un radio interface. The DeNB 220 operates as a donor node for the relay node 240. The DeNB 220 communicates with an enhanced Node Basestation (eNB) 221 using an X2 interface, and communicates with a serving GateWay (sGW) 230 using an S1-U interface. The sGW 230 also communicates with the eNB 221 over an S1-U interface.

In order to reach the second configuration from the first configuration, a handover is performed in which the source node is the relay node 240 and the target node is the DeNB 220 which, in the first configuration, was operating as the donor node 220 for the relay node 240.

In the first configuration, downlink data, travelling from the sGW 230 to the user equipment 210 is first transmitted from the sGW 230 to the DeNB 220. The data may be transmitted in a series of data packets or single data units (SDUs). If transmitted in such a series, the series may be sequentially marked, so that each data packet includes a number or marking by which it can be placed in order, for example, for processing. The data packets received by the DeNB 220 may be disassembled and reassembled into new packets before being transmitted on to the relay node 240. Each reassembled packet may contain the downlink data from a corresponding disassembled packet, and may be identical, or substantially identical but differently marked, to the corresponding packet. Alternatively, the data packets received by the DeNB 220 may be simply transmitted to the relay node 240. A series of sequentially marked data packets containing downlink data and transmitted from the DeNB (or donor node) 220 to the relay node 240, or intended for being so transmitted, shall be referred to as donor packets.

The downlink data received by the relay node 240 is then transmitted to the user equipment 210. Again, the data may be transmitted in a series of data packets. If transmitted in such a series, the series may be sequentially marked, so that each data packet includes a number or marking by which it can be placed in order, for example, for processing. If the data was received by the relay node 240 as a series of data packets, those packets be disassembled and reassembled into new packets before being transmitted on to the user equipment 210. Each reassembled packet may contain the downlink data from a corresponding disassembled packet, and may be identical, or substantially identical but differently marked, to the corresponding packet. Alternatively, the data packets received by the relay node 240 may be simply transmitted to the user equipment 210. A series of sequentially marked data packets containing downlink data and transmitted from the relay node 240 (or donor node) to the user equipment 210, or intended for being so transmitted, shall be referred to as relay packets.

In the second configuration, the relay node 240 can communicate with the DeNB 220 over a Un radio interface. However, the user equipment 210 can communicate directly with the DeNB 220 over the Uu radio interface. No relay node is required between the user equipment 210 and the DeNB 220.

In the second configuration, downlink data, travelling from the sGW 230 to the user equipment 210 is first transmitted from the sGW 230 to the DeNB 220. The data may be transmitted in a series of data packets or single data units (SDUs). If transmitted in such a series, the series may be sequentially marked, so that each data packet includes a number or marking by which it can be placed in order, for example, for processing. The data packets received by the DeNB 220 may be disassembled and reassembled into new packets before being transmitted on to the user equipment 210. Each reassembled packet may contain the downlink data from a corresponding disassembled packet, and may be identical, or substantially identical but differently marked, to the corresponding packet. Alternatively, the data packets received by the DeNB 220 may be simply transmitted to the user equipment 210.

FIG. 6 is a flowchart illustrating a method embodying the present invention. In step S1 the donor node 220, for example, a base station or DeNB, receives a handover request. The handover request may originate at, and be transmitted from, the user equipment 210. A handover request is usually made when the offset in a measured quantity of the serving cell (area served by the serving node) to a neighbouring cell becomes bigger than a configured threshold and a configured time-to-trigger has elapsed. Alternatively, a handover request may be triggered by a quality of service indicator falling below a pre-determined threshold value.

In step S2, the donor node 220 begins buffering donor packets in a temporary buffer. The temporary buffer is distinct from the transmission buffer common in communications components.

A handover request may have been issued due to some difficulty in delivering relay packets to the user equipment 210. In step S3 a status message is transmitted from the relay node 240 to the donor node 220 containing an indication of the first (first in this specification meaning sequentially earliest) relay packet not considered to have been received by the user equipment 210. The indication may be made by reference to a sequential marking attributed to a data packet containing the downlink data of the first undelivered relay packet, that is, a corresponding data packet.

In step S4, the donor node 220 transmits an update message to the relay node 240 indicating the first donor packet to be stored in the temporary buffer.

FIG. 7 illustrates a control signalling and buffering process embodying the present invention. Uplink and downlink user data paths are shown at the top of the diagram. The remainder of the diagram illustrates the process of handover. The relay node 240 is marked (S) to denote that it is the source node in the handover process. Correspondingly, the donor node 220 is marked (T) to denote that it is the target node in the handover process.

In the following example, the downlink data is user data, and it is transmitted in PDCP packets. Donor (data) packets 4, 5, 6, correspond to relay (data) packets 15, 16, 17 respectively. Forwarded data packets X, Y, Z correspond to relay packets 15, 16, 17, respectively.

Data packets 4, 5, 6, shown towards the top of the diagram, are sent over the Un radio interface and received in the relay node 240 from the donor node 220 then transferred to the PDCP entity in the relay node 240 for transmission to the user equipment 210. This transfer will involve the disassembly of the Un PDCP packets and re-assembly of PDCP packets for transmission over the Uu interface between the relay node 240 and the user equipment 210. This re-assembly will potentially use different PDCP sequence numbers as sequential markings from those PDCP sequence numbers (4, 5, 6) used as sequential markings over the Un interface. The re-assembled PDCP packets are shown as packets with Uu PDCP sequence numbers 15, 16 and 17, which correspond to packets with Un PDCP sequence numbers 4, 5 and 6 respectively.

In this embodiment, the Radio Link Control level protocol between the relay node 240 and the donor node 220 is used to acknowledge that data packets 4, 5, 6 were received by the relay node 240. Packets 4, 5, and 6 are then removed from the transmission buffer at the donor node 220.

The data transfer paths ending in a cross denote unsuccessful data transmissions.

Since data packets having Uu PDCP sequence numbers 15, 16, 17 are not considered to have been successfully delivered to the user equipment, the relay node 240 makes a handover or handoff decision P3. A handover request message M4 is then transmitted from the relay node 240 to the donor node 220.

In this embodiment the donor node 220 can start buffering downlink data packets (into a temporary downlink buffer) after receiving the handover request M4 from the relay node 240 and performing a successful admission control process P5 since it knows that handover is likely to be imminent. At the same time it forwards the buffered data packets to the relay node. The data packets are not removed from the temporary downlink buffer even after delivery to the relay node 240 has been acknowledged.

Call admission control is the procedure in the eNB to decide whether or not the requested bearer should be established in case of radio congestion. Call admission control takes into account the resource situation in a cell, the QoS requirements for the new Evolved Packet System (EPS) bearer as well as priority levels and the currently granted QoS levels for active sessions in that eNB. The call admission control algorithm is eNB vendor specific and not standardised (by 3GPP).

A handover request acknowledgment message M6 is transmitted from the donor node 220 to the relay node 240.

In the example the DeNB will store data packets having a Un PDCP sequence number of 7 onwards in the temporary DL buffer. Note that the DeNB does not have data packets having Un PDCP sequence numbers 4, 5, or 6 stored in the temporary downlink buffer as these were already sent to the relay node 240 before the donor node 220 had started buffering in the temporary downlink buffer.

A message M7 RRCConnectionReconfiguration is transmitted from the relay node 240 to the user equipment 210. The RRCConnectionReconfiguration establishes and maintains a signalling Radio Bearer (sRB) between the relay node (or other eNB) and the user equipment. Process P6 detaches the user equipment 210 from the source node and synchronises it to the target node.

A message M8 is transmitted from the relay node 240 to the donor node 220 and informs the donor node 220 of the Uu PDCP sequence number of the first data packet not considered to have been received by the user equipment 210.

At step S3 a PDCP control information message, ‘SN Status’ M8a, is sent as a status message from the relay node 240 to the donor node 220. By means of the SN Status message M8a, the relay node 240 informs the donor node 220 of the Un PDCP sequence number for the first downlink data packet not considered to have been received by the user equipment 210. All the PDCP data packets with a Un PDCP sequence number greater than this need to be forwarded to the target node.

It is also possible that the SN Status message M8a could contain more detailed information on exactly which packets from a sequence of transmitted packets need to be forwarded, for example in the case where some packets were acknowledged as received by the user equipment 210 and some were not. This could be achieved by using a bitmap in addition to, or as part of, the SN Status message to indicate which bits were successfully received by the user equipment.

At step S4 a PDCP control information message, ‘SN Status Update’ M8b, is sent as an update message from the donor node 220 to the relay node 240. The donor node 220 checks the temporary downlink buffer and identifies that, of the data packets with a Un PDCP sequence number equal to or greater than that of the first non-received data packet, it does not have the data packets having Un PDCP sequence numbers 4,5,6 as sequential markings. The donor node 220 then informs the relay node 240 by means of the SN Status Update M8b that the Un PDCP sequence number of the first downlink data packet it has buffered (packet 7) in the temporary downlink buffer.

In step S5 the relay node 240 forwards in the uplink direction only the undelivered downlink data from data packets which the donor node 220 does not have buffered in the temporary downlink buffer. In the example in FIG. 7, the relay node 240 forwards to the donor node 220 packets 4, 5, and 6 only.

In embodiments of the present invention, Un and Uu PDCP sequence numbering is different (4,5,6→15,16,17). The donor packets and relay packets are numbered with Un PDCP sequence numbering and Uu PDCP sequence numbering respectively. The same sequence is retained, though the positions of the sequences are independent of one another. Sequential markings are not limited to sequence numbers, and can extend to any other information that can be used to define a packet's position within a range in order to allow unambiguous, or substantially unambiguous, sequencing of data.

The SN Status M8a signals the Un PDCP sequence number corresponding to the Uu PDCP sequence number indicated in SN Status Transfer M8. The Un PDCP sequence number is used to correctly identify the first data packet that needs to be forwarded to the target node (15 mapped from 4). Additionally some user equipment identification may be required for successful transmission from the target node to the user equipment 210.

SN Status update M8b is used to indicate the first downlink data packet that the donor node 220 has buffered in the temporary downlink data buffer. Data forwarded in the uplink direction from the relay node 240 to the target node is all data from data packets not yet received by the user equipment 210 in the range:
First Packet=Uu PDCP sequence number (15)
Last packet=Uu PDCP sequence number (17) (as donor node has started
buffering in the temporary downlink buffer from Un PDCP sequence number=7)

In a case in which there are no data packets which require forwarding to the donor node, it may be possible to omit the SN Status Update M8b.

These packets will receive different PDCP uplink sequence numbers X,Y,Z but could be identified to the donor node 220 by a dedicated radio bearer identity or Logical Channel ID (LCID) and embedded original PDCP Uu sequence numbers.

FIG. 8 shows an example of the use of control signalling to determine the correct data packets to be transferred from the relay node 240 in the uplink direction to the donor node 220 and then on to the user equipment 210 over the new radio interface link Uu(t). In this embodiment, packets 1, 2, 3 are delivered from the sGW 230 to the donor node 220 and transported over the Un radio interface to the relay node 240 before being successfully delivered and acknowledged at the user equipment 210 over the Uu interface. Packets 4, 5, 6 are successfully delivered and acknowledged as delivered over the Un interface (from the donor node 220 to the relay node 240) but not yet successfully acknowledged over the Uu interface (from the relay node 240 to the user equipment 210). The diagram shows how in this embodiment the PDCP sequence numbers are different from the Un (the donor packets) to the Uu (the relay packets) interfaces.

In FIG. 8, donor (data) packets 4, 5, 6, correspond to relay (data) packets 15, 16, 17 respectively. Forwarded data packets X, Y, Z correspond to relay packets 15, 16, 17, respectively.

The temporary buffer is marked ‘DL data buffer’, and starts at the donor packet having the sequential marking ‘7’, or Un PDCP sequence number ‘7’.

In FIG. 8, data packets having Un PDCP sequence numbers 4,5,6 (corresponding to data packets having Uu PDCP sequence numbers 15,16,17) have been transmitted from the donor node 220 to the relay node 240, acknowledged, and subsequently deleted from the donor node transmit buffer. As a handover is now taking place, in order that the handover be completed without any data being lost, it is desirable for these packets have to be transferred back to the donor node 220 to then be transferred to the target node (the donor node 220 in this case) and on to the user equipment 210 over the new radio interface (Uu(t)).

SN Status message M8a indentifies the sequence number of the data packet where the forwarded back data packets should start from (information that can only be known from the relay node). The sequence number identified by SN Status message M8a is the sequentially earliest number of the data packets considered not to have been received by the user equipment 210. SN Status Update M8b then identifies the sequence number for the first packet that was buffered in the temporary downlink buffer by the donor node 220.

Message M8 is the SN Status Transfer from the relay node 240 to the target node, which in this case is the donor node 220. The SN Status Transfer message M8 conveys the downlink PDCP sequence number transmitter status of EUTRAN Radio Access Bearers (E-RABs) for which PDCP status preservation applies (i.e. for Radio Link Control Acknowledgment Mode). E-RABs are used to establish, modify, and release resources for user data transport once a user equipment context is available in the cell served by an eNB. The downlink PDCP sequence number transmitter status indicates the next Uu PDCP sequence number that the target node shall assign to new data packets, not yet having a PDCP sequence number. The SN Status Transfer M8 may also include a bit map of the receiver status of an out of sequence uplink data packets that the user equipment 210 needs to retransmit to the target node. Sending this message may be omitted if none of the E-RABs of the user equipment are operating in a mode which utilises PDCP status preservation.

Message M8a is an SN status message. In this embodiment, the relay node 240 sends a Un SN Status Transfer message to the target node to convey the uplink Un PDCP SN receiver status and the downlink Un PDCP SN transmitter status. This Status message M8a carries the sequence number of the last donor packet delivered over the Un interface for which the corresponding relay packet has not been acknowledged by the user equipment 210 as successfully delivered. Where the target node is also the donor node 220, this sequence number can be used by the donor node together with the previous SN Status Transfer M8 to add the correct sequence number the first PDCP PDU that is required to be forwarded on to the target node by enabling the donor node 220 to map Uu sequence numbers to Un sequence numbers. Receipt of this message also enables correct Uu PDCP sequence numbers to be added to data packets stored in the temporary buffer (labelled with Un PDCP sequence numbers 7, 8 in the Figure) for transmission from the donor node 220 to the user equipment 210.

Message M8b is the SN Status Update message transmitted from the relay node 240 to the donor node 220 as an update message. The SN Status Update is used to indicate the first downlink data packet (donor packet) that the donor node 220 has buffered in the temporary buffer, or started to buffer in the temporary buffer. This Status Update Message is required so that the relay node 240 knows which packets to deliver to the donor node 220 for subsequent forwarding to the target node. Without the temporary buffer during handover and this signal, there will be a waste of Un resources as all donor packets (4,5,6,7,8) would have to be forwarded back from the relay node 240 to the donor node 220.

The donor packets having Un PDCP sequence numbers 4, 5, 6, are forwarded in the uplink direction from the relay node 240 to the donor node 220. These packets are disassembled and reassembled and given the sequential markings X, Y, Z, with the Un PDCP numbers embedded in the reassemble data packets.

The donor node 220, being the target node in this case, can then transmit the data from received forwarded data packets X, Y, Z over the new Uu radio interface Uu(t) to the user equipment 210. The data is transmitted over the radio interface Uu(t) in data packets marked with sequential markings 15, 16, 17, with 15 being the earliest of the Uu interface PDCP sequence numbers (relay packet sequential markings) of the relay packets not considered to have been received by the user equipment 210.

Optionally, a PDCP status report can be triggered after the SN Status Update message M8b. This PDCP status report could be used to identify exactly which packets are not considered to have been successfully delivered to the user equipment. This status report could reduce the amount of data forwarded from the donor node 220 to the target node, and/or retransmitted from the target node to the user equipment 210 as some of the forwarded or retransmitted data may have been successfully delivered to the user equipment 210 already. As an alternative to a PDCP status report a bitmap of the missing data packets, which will be eventually required to be forwarded on to the user equipment 210 can also be used.

When data packets are forwarded in the uplink direction from the relay node 240 to the donor node 220, some mechanism may be provided for the donor node 220 to identify that these forwarded data packets are data packets intended for data forwarding to the new target node. This could be achieved in several ways. For example, a unique identifier could be assigned to the stream of data packets by using a specific logical channel ID (LCID), which is transported with the data. This specific LCID would allow the donor node 220 to identify that the forwarded data packets coming in the uplink direction from the relay node 240 are data packets containing data intended for forwarding to the new target node, and eventually on to the user equipment 210. This specific LCID can be set up over the Un interface between the relay node 240 and the donor node 220, and this can be controlled by semi-static Radio Resource Control (RRC) signalling. Alternatively, these data packets may be identified as containing forwarded data by utilising MAC level control signalling.

When multiple user equipments 210 are connected to a single relay node 240, identification of the relay packets for each user equipment 210 will be required. One way to accomplish this would be to add a user equipment identification data field to each PDCP data packet transferred over the Un (donor node to relay node) radio interface. Alternatively, a specific radio bearer (RB) per user equipment can be set up over the Un interface and this can be controlled by semi-static Radio resource Control (RRC) signalling. As a further alternative, headers could be added to data packets according to the GTP-U protocol in order to specify the user equipment for which the data is intended.

FIG. 9 shows components in a communication system and the interfaces between the components. A detailed description of some of the components and connections between components is omitted here as it is described above in relation to FIG. 5. A first, pre-handover, configuration is shown to the left of the arrow. To the right of the arrow is a second, post-handover, configuration. In the embodiment shown in FIG. 9, the donor node 220 and the target node 221 are separate entities.

The first configuration and path of downlink data in the first configuration are as described above in relation to FIG. 5.

In order to reach the second configuration from the first configuration, a handover is performed in which the source node is the relay node 240 and the target node is the eNB 221.

In the second configuration, the relay node 240 can communicate with the DeNB 220 over a Un radio interface. However, the handover has now been performed and the user equipment 210 is communicating directly with the target node 221 over a Uu radio interface.

In the second configuration, downlink data, travelling from the sGW 230 to the user equipment 210 is first transmitted from the sGW 230 to the target node 221. The target node 221 may also have received forwarded data from the donor node 220 which was not considered to have been successfully delivered during the handover process. The first forwarded data may be marked with the next sequence number following the sequence number of the last data packet to be successfully transmitted from the relay node 240 to the user equipment 210. Alternatively, said next sequence number may be embedded within the forwarded data.

In FIG. 9, the target node 221 is a neighbour eNB to the DeNB 220 for the relay 240. Typically, a handover to a target node 221 neighbouring the donor node 220 will occur when the user equipment moves out of the coverage area of the relay node 240 and into the coverage area of a eNB that is not the DeNB 220 of the source relay node 240. For this handover to occur without data loss, a mechanism needs to be in place to stop the delivery of packets by the relay and resume packet delivery from the target node without losing packets during the handover process. In this case undelivered data packets will have to be forwarded first over the Un interface in the uplink direction from the relay node 240 to the DeNB 220 before being forwarded on to the target eNB 221.

FIG. 10 shows an example of the use of control signalling to determine the correct data packets to be transferred from the relay node 240 to the DeNB 220 and on to the user equipment 210 over the new radio interface link Uu(t). In this figure data packets having Uu PDCP sequence numbers 15,16,17 have been transmitted from the DeNB 220 to the relay node 240, acknowledged, and deleted from the DeNB transmission buffer. However, these data packets are not considered to have been successfully delivered to the user equipment 210. The temporary data buffer at the DeNB 220, marked as ‘DL data buffer’ does not begin buffering downlink data packets until the data packet having Un PDCP sequence number ‘7’. As a handover is now taking place, the data packets having Uu PDCP sequence numbers 15, 16, 17 have to be forwarded to the DeNB 220 to then be transferred to the target (a different eNB in this case) and on to the user equipment 221 over the new radio interface (Uu(t)). The data packets from the temporary buffer (data packets having Un PDCP sequence numbers 7 and 8) also have to be transferred from the DeNB 220 to the target node 221 to then be transmitted to the user equipment 210 over the Uu(t) radio interface.

In FIG. 10, donor (data) packets 4, 5, 6, correspond to relay (data) packets 15, 16, 17 respectively. Forwarded data packets X, Y, Z correspond to relay packets 15, 16, 17, respectively.

In this case it can be seen that the control signals M8a, the status message, and M8b, the update message, are used. The status message M8a from the relay node 240 to the DeNB 220 indentifies the Un PDCP sequence number corresponding to the first Uu PDCP data packet not considered to have been successfully delivered to the user equipment 210 (information that can only be known from the relay node (source) 240. Update message M8b from the DeNB 220 to the relay node 240 identifies the starting Un PDCP sequence number for the first data packet that was buffered in the temporary buffer at the DeNB 220.

Additionally in this case the packets are forwarded on to the target node 221. The sequence number used for this forwarding will be the same as used over the Un interface, and only in the target node 221 will the SN Status Transfer Message M8 signal be used to correctly number the PCDP data packets with the first of the data packets forwarded to the target node 221 numbered with the Uu PDCP sequence number identified in the SN Status Transfer message M8 for delivery over the new Uu(t) interface.

The data packets (labelled with Un PDCP sequence numbers 7, 8 in FIG. 10) stored in the temporary buffer are also forwarded from the donor node 220 to the target node 221. Once at the target node 221 the data packets from the donor nodes' temporary buffer can be labelled with the correct Uu PDCP sequence numbers (18 and 19 in FIG. 10) and transmitted to the user equipment 210.

The term ‘data packet’ is generally employed in the foregoing description. However, the skilled reader will understand that equivalent terms such as ‘single data unit’, or ‘SDU’, could be used as a direct equivalent for ‘data packet’. The term ‘data packet’ should be seen to encompass both ‘donor packets’ and ‘relay packets’. ‘Donor packets’ are data packets transmitted from the donor node 220 to the relay node 240. The sequential markings of the donor packets may be Un PDCP sequence numbers. ‘Relay packets’ are data packets transmitted from the relay node 240 to the user equipment 210. The sequential markings of the relay packets may be Uu PDCP sequence numbers.

Downlink data from the data packets discussed in this document could be taken to be user data.

In any of the above aspects, the various features may be implemented in hardware, or as software modules running on one or more processors. Features of one aspect may be applied to any of the other aspects.

The invention also provides a computer program or a computer program product for carrying out any of the methods described herein, and a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

1. A method in handover of a user equipment in a communications system from communicating with a donor node via a relay node, to communicating with a target node, the donor node being operable to transmit downlink data to the relay node in a series of donor packets, the donor packets being sequentially marked, the relay node being operable to then transmit the downlink data to the user equipment in a series of relay packets, the relay packets also being sequentially marked, the method comprising:
receiving a handover request at the donor node and, upon receipt, beginning buffering of the donor packets in a temporary buffer at the donor node;
transmitting a status message from the relay node to the donor node indicating a first of the relay packets not considered to have been received by the user equipment; and
transmitting an update message from the donor node to the relay node indicating the first donor packet buffered in the temporary buffer.

2. The method according to claim 1, further comprising forwarding uplink, from the relay node to the donor node, all downlink data from relay packets not considered by the relay node to have been received by the user equipment and which are sequentially earlier than the first donor packet buffered in the temporary buffer.

3. The method according to claim 1, further comprising
accompanying said forwarded data with an indication to the donor node that the forwarded data are intended for forwarding to the target node of the handover request.

4. The method according to claim 1, further comprising
forwarding data from the donor packets in the temporary buffer from the donor node to the target node.

5. The method according to claim 1, wherein
the sequential markings of the donor packets are different from the sequential markings of the relay packets, and each relay packet corresponds to a donor packet in that the relay packet contains the downlink data from the corresponding donor packet, and
the status message uses the sequential marking of the corresponding donor packet to identify the first of the relay packets not considered to have been received by the user equipment.

6. The method according to claim 1, further comprising
transmitting a further status message from the relay node to the target node indicating, using the sequential marking of the relay packet, the first relay packet not considered to have been received by the user equipment.

7. The method according to claim 1, further comprising
transmitting the downlink data of a donor packet in the temporary buffer from the donor node to the relay node.

8. The method according to claim 7, further comprising
at the donor node, upon receiving acknowledgment that the downlink data from the donor packet in the temporary buffer have been received by the relay node,
retaining the donor packet in the temporary buffer.

9. The method according to any claim 1, further comprising
transmitting, from the relay node to the donor node, an indication of the relay packets, from a defined sequence of relay packets, not considered to have been received by the user equipment.

10. The method according to claim 1, used in a communications system operating according to a LTE-A protocol.

11. The method according to claim 10, wherein the donor node is a donor enhanced node base station according to the LTE-A protocol.

12. A communications system operable to perform a handover from a first configuration in which a user equipment communicates with a donor node via a relay node, to a second configuration in which the user equipment communicates with a target node, wherein
when communicating according to the first configuration, the donor node is operable to transmit downlink data to the relay node in a series of donor packets, the donor packets being sequentially marked, and the relay node is operable to then transmit the downlink data to the user equipment in a series of relay packets, the relay packets being sequentially marked;
and, in performing the handover,
the donor node is operable to receive a handover request and, upon receipt, to begin buffering of the donor packets in a temporary buffer;
the relay node is operable to transmit a status message to the donor node indicating a first relay packet not considered to have been received by the user equipment; and
the donor node is operable to transmit an update message to the relay node indicating the first donor packet buffered in the temporary buffer.

13. A relay node for use in a communications system operable to perform a handover from a first configuration in which a user equipment communicates with a donor node via the relay node, to a second configuration in which the user equipment communicates with a target node, wherein
when communicating according to the first configuration, the relay node is operable to receive downlink data from the donor node in a series of donor packets, the donor packets being sequentially marked, and to transmit the downlink data to the user equipment in a series of relay packets, the relay packets being sequentially marked;
and, in performing the handover,
the relay node is operable to transmit a status message to the donor node indicating a first relay packet not considered to have been received by the user equipment; and
the relay node is operable to receive from the donor node an update message indicating the first donor packet buffered in a temporary buffer which began buffering donor packets upon receipt of a handover request at the donor node.

14. A computer program which, when executed on a computing device of a telecommunications node, causes the node to become the relay node according to claim 13.

15. A donor node for use in a communications system operable to perform a handover from a first configuration in which a user equipment communicates with the donor node via a relay node, to a second configuration in which the user equipment communicates with a target node, wherein
when communicating according to the first configuration, the donor node is operable to transmit downlink data to the relay node in a series of donor packets, the donor packets being sequentially marked, for subsequent transmission to the user equipment as a series of relay packets also being sequentially marked;
and, in performing the handover,
the donor node is operable to receive a handover request and, upon receipt, to begin buffering of the donor packets in a temporary buffer, and to receive a status message from the relay node indicating a first relay packet not considered to have been received by the user equipment; and
the donor node is operable to transmit an update message to the relay node indicating the first donor packet buffered in the temporary buffer.

16. A computer program which, when executed on a computing device of a telecommunications node, causes the node to become the donor node according to claim 15.
